(19) United States
(12) Patent Application Publication
(10) Pub. No.: US 2002/0145626 A1
(43) Pub. Date: Oct. 10, 2002

(54) Interactive method and system for human networking

(75) Inventors: Ian Richards, Austin, TX (US); Joy Palmer, Bath (GB)

Correspondence Address: SIMON, GALASSO & FRANTZ PLC, P.O. BOX 26503, AUSTIN, TX, 78755-0503, US

(73) Assignee: Interknectives

(21) Appl. No.: 09/781,127

(22) Filed: Feb. 9, 2001

Related U.S. Application Data
(60) Provisional application No. 60/182,107, filed on Feb. 11, 2000.

(51) Int. Cl. G09G 5/00

(52) U.S. Cl. 345/741

(57) ABSTRACT

Various methods for providing personal, management training and development and organizational capability through the use of interactive, software-based games and tools. In accordance with one embodiment, the method includes identifying an individual's personal, networking style and capabilities through the use of interactive, computer software tools. In accordance with a second embodiment, the method provides guidance on personal, human networking through the use of interactive, computer software. In accordance with a third embodiment, the method provides personal guidance through interactive software-program tools that deliver said guidance in a human context through the use of a humanized, virtual coach.

### CLAIM OF PRIORITY

The present non-provisional patent application is a continuation of provisional patent application No. 60/182107, filed on Feb. 11, 2000.

### FIELD OF THE INVENTION

The present invention relates to entertainment, design and analytical and diagnostic tools involving data input by the user and graphical display of the results. In particular, the invention relates to interactive tools that are suitable for use in the workplace, at home or in educational institutions.

### BACKGROUND OF THE INVENTION

The use of the internet is now commonplace with approximately 60 million people using the medium for communication and, to a lesser but growing extent, for remote, electronic purchasing. The field of management games and exercises is also quite well developed and many companies now also offer workshop-based training and development exercises on paper, video and CD-ROM. Existing management and personal development exercises have not considered the impact of human and social behavior in a way that provides useful and valuable information to the user in an interactive form. One example of this is the behavioral factors that affect a person's human networking capability and the economic benefits of improving the capability. Networking is currently thought of as either an infrastructural model for connecting computers or as a way of sharing details about people who could enhance another person's business opportunities e.g. names and addresses and types of trading needs such as those provided at the web site of Biz2biz.com, or sharing of information about events and seminars such as those provided by Networker.com.

### SUMMARY OF THE INVENTION

Various methods for using computer software tools are provided. In accordance with one embodiment, the method includes identifying an individual's personal, networking style and capabilities through the use of interactive, computer software games or tools. In accordance with a second embodiment, the method provides guidance on personal, human networking through the use of interactive, computer software games or tools. In accordance with a third embodiment, the method provides personal guidance through interactive software-program tools that deliver said guidance in a human context through the use of a humanized, virtual coach.

### BRIEF DESCRIPTION OF THE DRAWINGS

FIG. 1 is a typical monitor screen view of the starting point for a data acquisition phase;

FIG. 2 is a typical monitor screen view after the user has entered their name and other personal details and used a PC input device such as a mouse to create a new network contact;

FIG. 3 is a typical monitor screen view after the user has entered the name and details relating to the contact associated with the second sphere and then created a third sphere, relating to a second network contact;

FIG. 4 is a typical monitor screen view after the user has created a third network contact and selected a position for a fourth network contact;

FIG. 5 is a typical monitor screen view of user-defined connections between the user and each network contact;

FIG. 6 is a typical monitor screen view of the drop-down menu of user-selectable options relating to the category of Trust for the second network contact;

FIG. 7 is a typical monitor screen view of the drop-down menu of user-selectable options relating to the category of Knowledge for the second network contact;

FIG. 8 is a typical monitor screen view of the drop-down menu of user-selectable options relating to the category of Currency for the second network contact;

FIG. 9 is a typical monitor screen view of the modify mode in which the user can “drag and drop” spheres in order to re-position them;

FIG. 10 is a typical monitor screen view of the “talking head” coach providing guidance to the user in relation to the second network connection;

FIG. 11 is a typical monitor screen view of a completed data acquisition phase and resulting graphical display of the user's network status showing how each network contact lays in relation to the user and the “contextual spaces”;

FIG. 12 is a typical monitor screen view of part of a completed network connection map with interactive modification from the second network contact via a web page on a secure server;

FIG. 13 is a typical monitor screen view of an opening screen for a gaming embodiment;

FIG. 14 is a typical monitor screen view of the playing environment depicting a scene, by way of example, similar to outer space and an outline of user details;

FIG. 15 is a typical monitor screen view of a point in the game where the “talking head” prompts the player to select a “Space”;

FIG. 16 is a typical monitor screen view of a challenge presented by the game to the player in one of the “Spaces”;

FIG. 17 is a typical monitor screen view of a drop-down menu of contact names used to select and identify contacts specified in the on-screen network representation;

FIG. 18 is a flowchart of the software initiation and optional modes that may be selected by the user and that are described in more detail in the specified figures;

FIG. 19 is a process flow diagram of a game mode.

FIG. 20 is a process flow diagram of an analytical mode.

FIG. 21 is a process flow diagram of a design mode.

FIG. 22 is a process flow diagram of an interactive mode.

### DETAILED DESCRIPTION OF DRAWINGS

By way of example only, some embodiments of the invention will now be described in detail with reference to the accompanying drawings.

A particular embodiment of the present invention is concerned with adapting and improving known techniques to provide a powerful, engaging and valuable infotainment tool, i.e. it creates both valuable information and is entertaining at the same time, for both workplace and home use. It aims to extract key information relating to the myriad of human and social issues and characteristics that contribute to an individual's social and professional networking capability. Once these elements have been identified, they can be used to construct a plan of action against which the user can re-position their working or personal objectives.

A typical embodiment of the invention is an interactive, internet based tool for constructing a user's network of contacts in the workplace. The user accesses the tool by using browser software such as Microsoft Internet Explorer or Netscape Navigator on a personal computer (PC), Macintosh™, or network PC and enters the uniform resource locator (URL) for a specific website. From this website, the user can download the tool in either high quality graphics form or low quality graphics form, depending on the capability of the user's internet access (primarily determined by modem speed and line bandwidth) and system hardware.

On beginning a downloaded software program or software loaded from source media such as a CD-ROM, DVD, Zip™ disc or floppy disc that executes a networking exercise on a system such as a computer (PC, Macintosh™, network PC or other machine capable of running and displaying applications software programs), a user completes a registration process in which personal details are entered and the user is then presented with a series of instructions and objects. The data relating to personal details and all other user-defined data are stored in software-defined data files, either on a hardware system's (PC, Macintosh™, network PC etc) hard drive or on a removable media drive (floppy disc, Zip™ disc, magnetic tape or re-writeable CD-ROM for example), the data destination being definable by the user. An example system that would enable the software program to operate effectively would be a PC with a high speed processor (for example 600 MHz Intel Pentium™ III with MMX technology and 512K cache), 13 Gb Ultra ATA hard drive (5400 rpm), 8× DVD-ROM, 256 Mb SDRAM, 32 Mb Diamond Viper V770D AGP Graphics Card, Soundblaster 512V sound card, 15″ flat panel monitor, 3.5″ floppy drive, Microsoft Natural keyboard Elite, Microsoft Mouse, Microsoft Windows 98 second edition update, and Microsoft Office Internet Explorer 5.0.

On accessing the web site, the user may locate the tool access button on the first web page and click on the button to download the first part of the tool. In this embodiment, as the user completes registration information (such as, but not limited to, personal details, professional qualifications, goals, objectives) downloads of necessary software may be completed in parallel. In this embodiment, the user may be greeted by a 3-dimensional graphic user interface and an animated “talking head” virtual coach who helps the user to input information. User specific information may be supplied through user text entry, multiple choice from drop-down menus, responses to audio clips and videos, user-positioning of objects on the screen, and role-playing in on-screen animations.

In a particular embodiment, the user information specified in the registration process may be used to define a central “NetSphere” that identifies the user. The user may then be instructed to locate other spheres around them, corresponding to the people who they associate with in order to do their jobs. The people they work most frequently with may be placed closest to them. The formal organizational structure may be reflected by placing contacts who are more senior above them on the screen and more junior contacts may be placed below them. Customers who are important contacts may be defined as such from a drop down menu and identified, for example, by means of 3-D diamonds. Consideration of the relationships and networking capabilities of a person to a customer would be very valuable to businesses that desire strong customer relationship management. Suppliers may be equally identified, where desired, from a drop down menu as, for example, 3-D cubes. Each contact within the network may then connected to the user sphere by a line whose type denotes the importance of the relationship to the user. The type, in this embodiment, may be double lines, single lines or dotted lines denoting decreasing importance.

The data acquisition phase may continue with the definition of the types of currency traded between the user and network contacts. In this context, currency refers to characteristics of the relationship such as the level of mutuality and reciprocity of the relationship, the predictability of the relationship, the level of trust and the ability for each individual to express themselves. Some of the questions posed may be repeated within different phrasings to validate the responses. In one embodiment, the data acquisition phase may allow users to complete specific network connections in their entirety or allow desired network connections to be assessed according to a specific question category, for example, trust or mutuality or predictability.

When the data acquisition phase is completed, the user receives a 3-dimensional display of the relationship of each network contact to themselves and of each network contact to each other. The user may rotate the graphics displayed on the screen about a central axis so as to gain alternative views of the network relationships. Each network contact occupies a space that is defined according to responses provided during the data acquisition phase. These may be spaces such as, but not limited to, the knowledge space, the emotional space, or the development space (referred to herein as “NetSpaces”). These “NetSpaces” together form the 3-dimensional environment in which each network contacts' sphere is placed.

In one embodiment, the “talking head” virtual coach may provide an explanation of what the layout means, pointing out key network contacts for development and specific contacts that may need attention. In another embodiment, the user may provide an over-arching objective of what their network should provide, and the “talking head” virtual coach may provide an assessment of how close they are to achieving that objective, and what actions they may take to move them closer to achieving it.

In another embodiment, the user may take the results provided from the analysis and move the positions of the network contact spheres to where they should ideally be. This movement results in a series of suggestions from the “talking head” virtual coach, for actions to achieve that new arrangement.

In yet another embodiment, the user may complete their network analysis or design and save their current configuration to a data file on a computer's hard drive or removable media. The user may take the suggestions and comments that were provided by the “talking head” virtual coach and modify their networking behavior to achieve their desired outcomes. Following their implementation of their modified behavior and their observation of their network contact's reactions to their modified behavior, the user may return to the networking software program and enter their observations for review by the “talking head” virtual coach. The user and the “talking head” virtual coach may then assess the impact of the user's modified behavior and determine whether to refine the behavioral modifications still further, or if the behavioral modification achieved their desired results, move on to another network contact. In this way, the user interacts in a longitudinal manner with the networking software program and the “talking head” virtual coach to improve the networking capability and performance of the user.

In another embodiment, the network analysis of many individual users may be connected together to create an over-arching view of the connectivity within a group, department, organization, or organizations. In this embodiment, the individual network analyses for any community within or between organizations may be linked to create a view of, for example, the reach, depth of expertise, overall focus, types of relationships, and gain insight into the cultural drivers and values that connect the community of interest. Interested parties may then compare the results of the network analysis with their objectives and prepare an action plan for behavioral modification to achieve the desired network community.

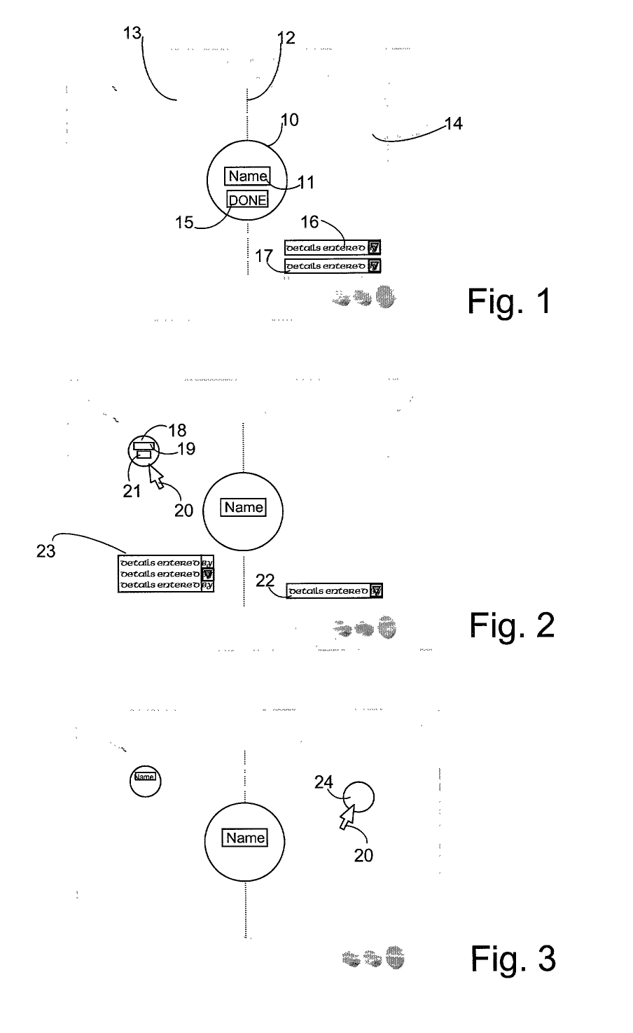

Referring to FIG. 1, the monitor screen has placed within its vertical and horizontal center a sphere 10 that contains a dialog box 11 containing the user's name, which has been automatically placed there by the system, referenced from the registration details held within the user data file that was saved on the hard drive of the computer or on removable media. The screen view is split down the vertical axis in the middle by line 12, or by the interface 12 formed between one half of the screen 13 in one color, shade or pattern and the other half of the screen 14 in a different color, shade or pattern. On reviewing the user name in the dialog box 11 for correctness and clicking on the button labeled “DONE” 15, additional dialog boxes 16 and 17 appear in the lower half of screen side 14 for the user to enter details relating to the user's objectives and goals. The spheres are drawn by executable code within the software program that is initialized at this stage of the program. The software program registers where the user has placed the screen cursor and, following a command from the user that may be a mouse click or a selection from a Windows-type toolbar or drop-down menu, draws a circle that is rendered to appear 3-dimensional. Such drawing effects are commonly available in packages such as Micrografx iGrafx Designer, Discreet's effect^{*} or Kinetix's 3D Studio Max.

FIG. 2 illustrates what happens when the user identifies a first network contact, such as someone who they depend on to do their job. By using the screen cursor 20 to click anywhere on the screen, a second sphere 18 is created. The user is instructed to place the spheres that represent their network contacts either above them, at the same level, or below them on the screen corresponding to whether their network contact is more senior, a peer, or more junior to them, respectively. A dialog box 19, containing the phrase “Please enter network contact's name” appears automatically in the center of the new sphere and the user completes the name details. On completion, the user clicks on button 21 which is labeled “DONE” and additional dialog boxes 22 and 23 appear in the bottom of screen side 13 in which further details of the first network contact are entered. These details are saved into data files that are held in a folder that also contains the user's central data file. The user may define the desired location of the data file folder. Following completion of the data entry to dialog boxes 22 and 23, the user clicks on button 21 to end the data definition for the first network contact.

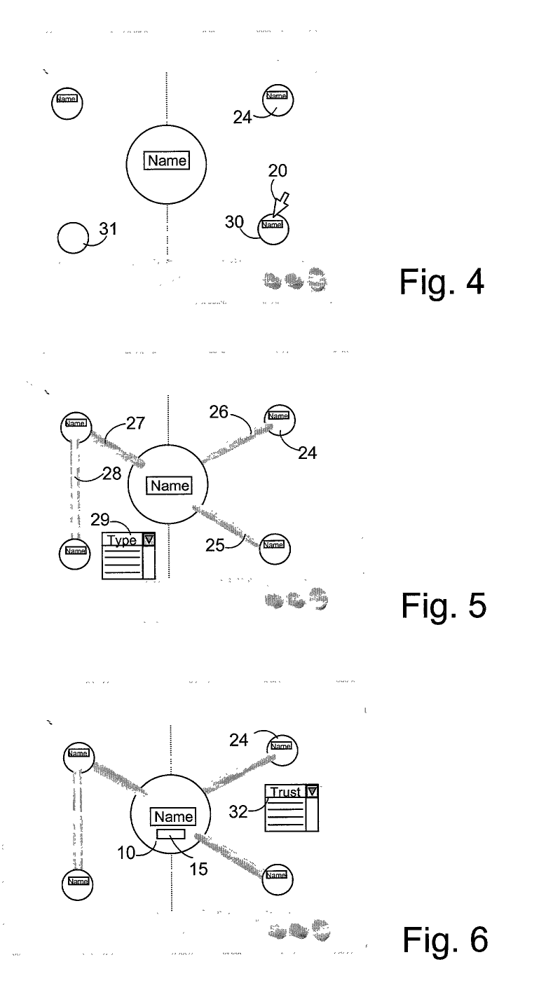

FIG. 3 shows the monitor screen view for entering data for a second network contact. The user repeats the process of placing the network contact at a position on the screen that equates to the second network contact's position in the organizational hierarchy, in relation to the user. The screen cursor 20 is placed in the desired position and a right click of the mouse places a new sphere 24 on the monitor screen. The same series of questions are repeated for the second network contact and after completion, a third network contact is defined as shown in FIG. 4. The user continues to define new spheres (e.g. 30 and 31) in the area around themselves until they have identified those network contacts who are most important for the successful fulfillment of their job.

FIG. 5 shows the user completing the connections between each network contact and the user's own sphere as shown by connections 25, 26, and 27. The user may also make connections between network contacts that do not connect directly with the user, as shown in connection 28. All of these connections are made by choosing a connection type from a drop-down menu list, 29, when the user clicks on the selection button (usually, but not always, the right hand mouse button, or from the on-screen toolbar). When the user has made all desired connections, additional attributes can be entered for each network contact. Connections between the spheres may be drawn to appear as 3-dimensional tubes by using commonly available rendering software programs. 3-dimensional rendering of tubes is a commonly available drawing tool and is present in software such as Microsoft Powerpoint and Micrografx iGrafx Designer. Powerpoint achieves this by creating 3-D circles with high degrees of perspective, effectively generating a tubular column that may be rotated or lengthened as desired.

FIG. 6 shows, by way of example, a drop down menu 32 of characteristics relating to the attribute TRUST. This drop down menu contains a series of statements and user-definable indicators that the user can select from as being relevant to the trust-based issues in the relationship between themselves 10 and the second network contact 24. Following completion of the TRUST attributes, the user clicks on button 15 marked DONE and details for this attribute are saved to the second network contact's data file and also to the user's data file.

FIG. 7 shows, by way of example, a drop down menu 33 of characteristics relating to the attribute KNOWLEDGE. This drop down menu contains a series of statements and user-definable indicators that the user can select from as being relevant to the knowledge-based issues in the relationship between themselves 10 and the second network contact 24. Following completion of the KNOWLEDGE attributes, the user clicks on button 15 marked DONE and details for this attribute are saved to the second network contact's data file and also to the user's data file.

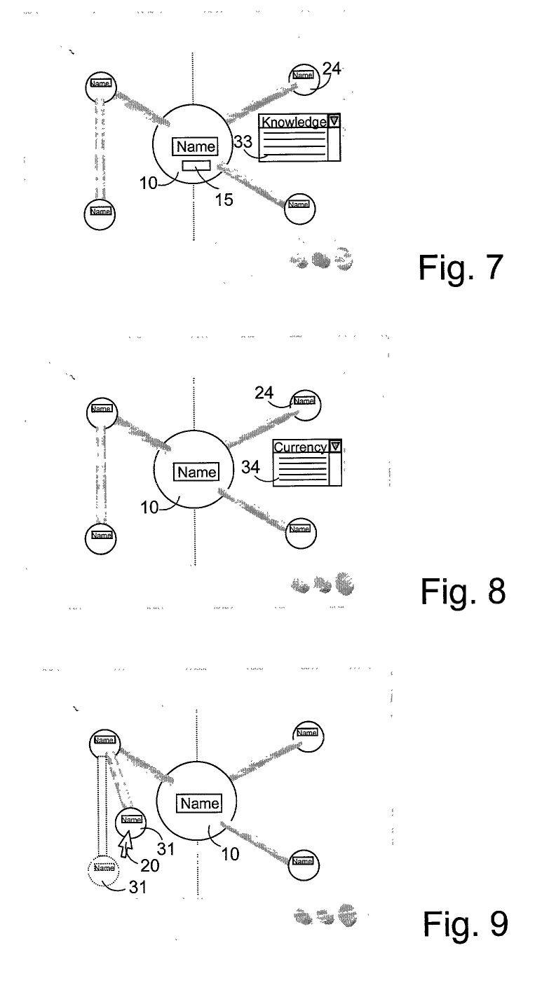

FIG. 8 shows, by way of example, a drop down menu 34 of characteristics relating to the attribute CURRENCY. This drop-down menu contains a series of statements and user-definable indicators from which the user can select those that describe most closely the currency on which the relationship is based with second network contact 24. Following completion of the CURRENCY attributes, the user clicks on button 15 marked DONE and details for this attribute are saved to the second network contact's data file and also to the user's data file.

FIG. 9 shows the “modify” mode in which the user can “drag and drop” sphere 31 from the position they originally placed it in (as shown by the dotted line sphere 31 and connection), moving it to a position that reflects a better overall position relative to the other spheres (as shown by the solid line sphere 31 and connection). Changes to these positions are noted in both the data files of the user and the contact(s) affected, and held as an additional, modifications data file.

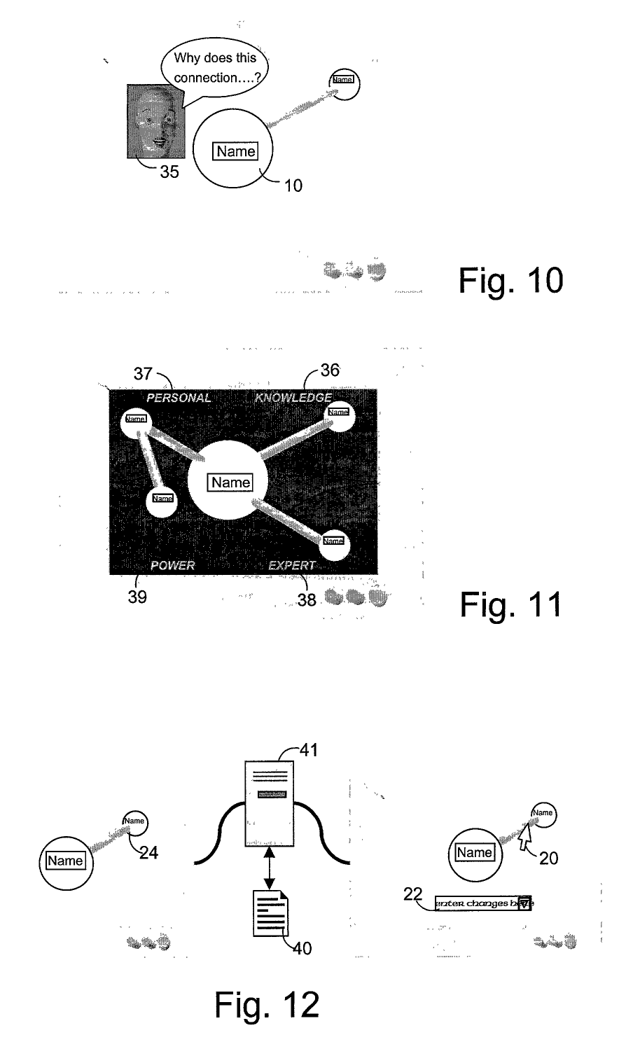

FIG. 10 shows an on-screen video or animation of a “talking head” virtual coach 35, an interactive coach and mentor who guides the user through choices and decision points at various levels and points in the exercise. The “talking head” virtual coach 35 can ask the user questions, via pre-recorded audio files or through intelligent voice synthesis methods, prompted by previous user inputs, that cause the user to reflect on the responses they give to different questions. Suitable speech synthesis programs are commercially available, such as Lucent Technologies' Text-to-Speech engine. The “talking head” virtual coach 35 can prompt the user to validate responses they have given or provide “what-if” scenarios, such as those relating to seemingly conflicting responses or proposed actions for improvements. The “talking head” coach 35 can welcome the user to the tool at the start of the program, explain to the user how the system works, and summarize areas for improvement and define action plans before the user exits from the software program.

FIG. 11 shows how the results of the data acquisition, analysis and graphical representation may be displayed in terms of different “spaces”. These “spaces” are defined by the user input and may include, but are not restricted to, Knowledge Space 36, Personal Space 37, Expert Space 38, or Power Space 39.

FIG. 12 shows how a user can employ the interactive mode to connect to a remote network contact via the internet, local area network, wide area network or other connectivity and communication network. In this mode, the user identifies the network contact sphere to be validated 24 from an existing network design or analysis, and completes two series of checks to ensure the correct network sphere is chosen.

On choosing and securing the appropriate network sphere 24, the software creates a secure copy of the network sphere's user-defined characteristics and displays them in a graphical form on a unique web page 40 on a secure web server 41. Creating such a web page is well-known to those skilled in the art of web page publishing and tools such as Macromedia's Dreamweaver or Microsoft Front Page may be used to achieve the desired web page. Once prepared, this web page may be automatically posted to an accessible but secure web site, the URL and password details of which may be sent to the network sphere's 24 email address, taken from the initial set-up details for this network contact. The first network contact whose details are contained within the network sphere 24 may then enter the unique web page address in their web browser and access the details entered by the user. The first network contact can then assess the responses provided by the user from web page 40, where access privileges have been allowed, and modify the responses according to their own views.

In a particular embodiment, the user defines which questions and responses the network contact will have access to and therefore how much information they will be able to modify. This allows more sensitive information to be excluded from the interactive mode. On completion of the modification by the first network contact, the system may send a copy of the changes to the user's own email address and the user may integrate the new, modified results into their existing responses and configuration. The differences between the original response by the user and the modified response by the first network contact are then calculated by the software application and the differences are presented to the user and reviewed by the “talking head” virtual coach 35.

In another embodiment, the user may request a network contact to complete the contact's own view of their relationship without any pre-existing information from the user. A secure web page containing a template NetSphere connected to the user's own NetSphere may be accessible by the network contact. The network contact may then complete the questions and select from statements that define their own NetSphere. The completed NetSphere would be saved back to the server where the secure web page was hosted, and then may be emailed to the user's email address. The user may then integrate the network contact's independent Netsphere definition by executing a sub-program in the networking software program that incorporates data from an attachment in the email into the data files of the user.

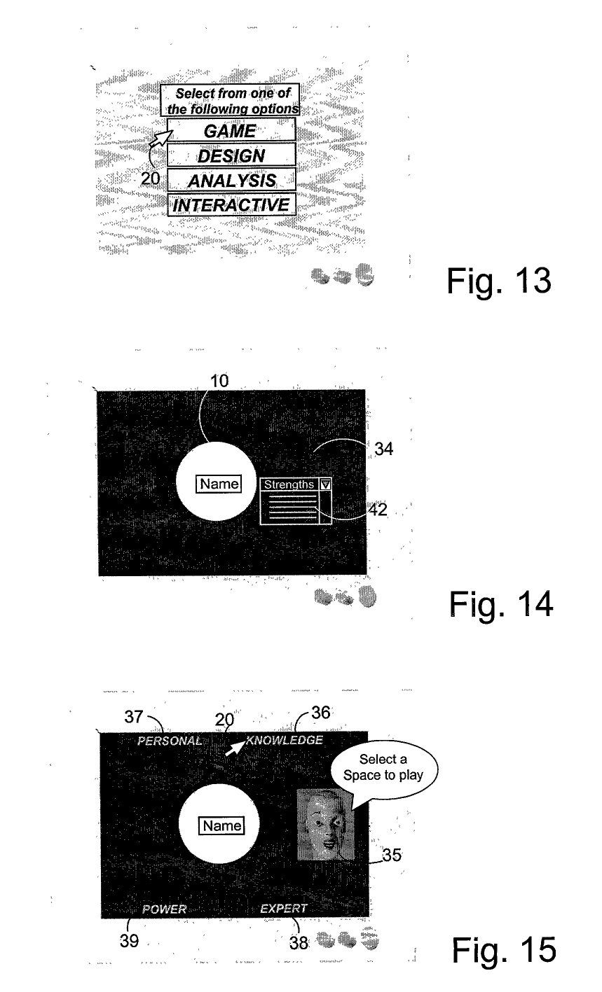

Another embodiment of the invention is illustrated in FIGS. 13 through 16 of the accompanying drawings. FIG. 13 shows the opening screen for an embodiment that functions as a game, introducing the concepts, terms and frameworks of the management development and training tool or of the personal development tool to the user. In FIG. 13, after the user has downloaded the game software from an internet web site or loaded the software from source media, such as a CD-ROM or DVD, the user selects the game option from a starting screen menu, using screen cursor 20, and the software for running the game program is loaded. As for any other of the embodiments, the user needs only to provide registration details once and may then select any function within the software without providing further personal details.

The system loads an on-screen view, as shown in FIG. 14, that shows a playing environment which is, by way of example, similar to a 3-D representation of outer space, 34. The process of creating this type of environment is well-known to those skilled in the art of multimedia and gaming software production, and can be created through software programs such as Discreet's Effect^{*} and Kinetix's 3D Studio Max, or through Sun Microsystems JAVA Development kit for stick and ball modeling. The user is represented, for example, in the middle of the screen by a “NetSphere” 10, which contains the user's details, strengths and weaknesses 42 in the context of the management technique that is the subject of the game. During the registration process, the user completes details of various characteristics that describe preferred working styles, behaviors and attitudes. These are saved into the user's central data file and translated by the software into the strengths, weaknesses and energy levels 42 that are defined at the beginning of the game and are contained within the NetSphere 10.

In a particular embodiment, a “talking head” virtual coach 35 appears on the screen and prompts the player to select the “Space” 36 in which they want to play, as shown in FIG. 15. The player selects from the on-screen display 36 to choose the playing environment. By way of example, in a networking management development and training game, the user may select from Knowledge, Power, Personal or Expert spaces in which to play. The player highlights a selection from the on-screen display and selects the environment (in this example, knowledge) with an on-screen cursor 20.

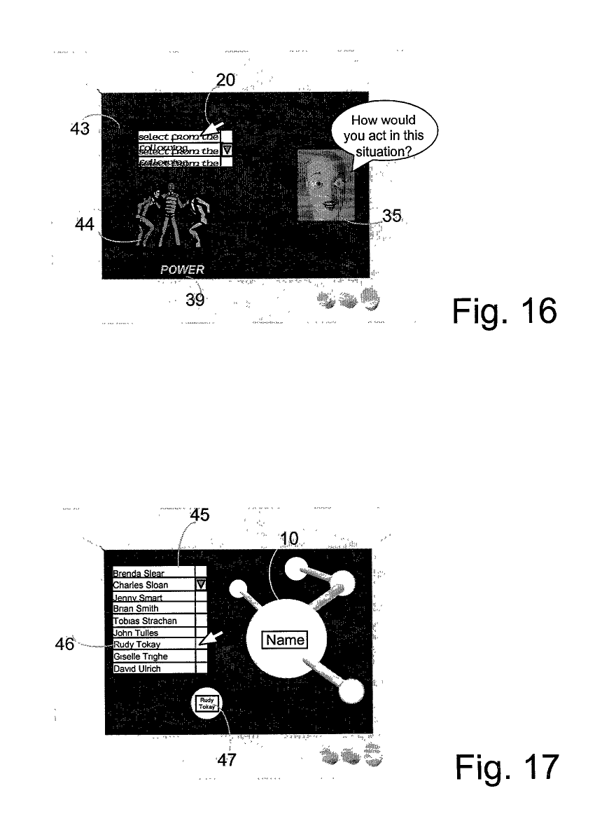

FIG. 16 shows one of the screens a player would see in which the game presents a challenge to the player as a video clip or animation. From the scenario presented in the video, the player would be introduced to concepts relevant to the management technique in question e.g. networking, and would score points dependent on responses to questions asked at the end of the video clip. In this example, the player has chosen the “Power” Space 39 and is responding to questions 43 relating to the animation shown in the video 44. In the illustrated embodiment, the “talking head” virtual coach 35 asks the questions of the player and the player selects from multiple choice answers in a drop down menu 43.

The player completes various tasks and challenges in each “Space” and may, at any time, save their existing configuration and exit, beginning the game again at another time at the point where they left off.

The player is presented with various aspects of the management technique in question in the form of game challenges and tasks. The points scored during the game are analyzed by the system to highlight those areas in which the player is strong or has weaknesses. The “talking head” virtual coach 35 may advise the player during the different phases of the game in each space to concentrate on particular aspects of their game, in order to strengthen those parts that are weak. The software also adjusts the challenges presented to the player in order to test the weak areas and create further opportunities for learning and development. As the player improves their capability in the management technique in question, for example in networking, the software determines the player's readiness and invokes the software that generates the “talking head” virtual coach 35 to suggest to the player that they might try the analytical function of the tool. If the player believes that they are ready, they can move immediately from the game function and begin the analytical function. Should the player decide to do this, the necessary personal details are copied into the analytical function software so as to enable a smooth and rapid transfer from the game mode to the analytical mode. At the same time, the configuration and scoring data generated in the game function are saved and stored as part of the player's central data file. The player can return to the game at any time and begin where they left off.

FIG. 17 shows a further embodiment where the user can select names from a drop-down menu to define the contact name of a particular network contact. By way of example, the drop-down menu may be populated with names of a user's contacts by importing or copying the names and other details of that user's contacts from their existing electronic address book or electronic contact management database file. The drop-down menu of contact names may be accessed, for example, by right-clicking on the mouse or other electronic pointing device used in conjunction with the user's personal computer, network pc or handheld, portable device. In this particular screen and mode of operation, it may be preferable to associate the click of the right-button of the mouse with a specific action, such as accessing the drop-down menu of contact names. Alternatively, the user may access the drop-down menu of contact names by pointing the mouse cursor to a function on the toolbar of a Microsoft Windows™ style user interface and left-button clicking on an icon or functional prompt that invokes a software sub-routine to present the drop-down menu of contact names.

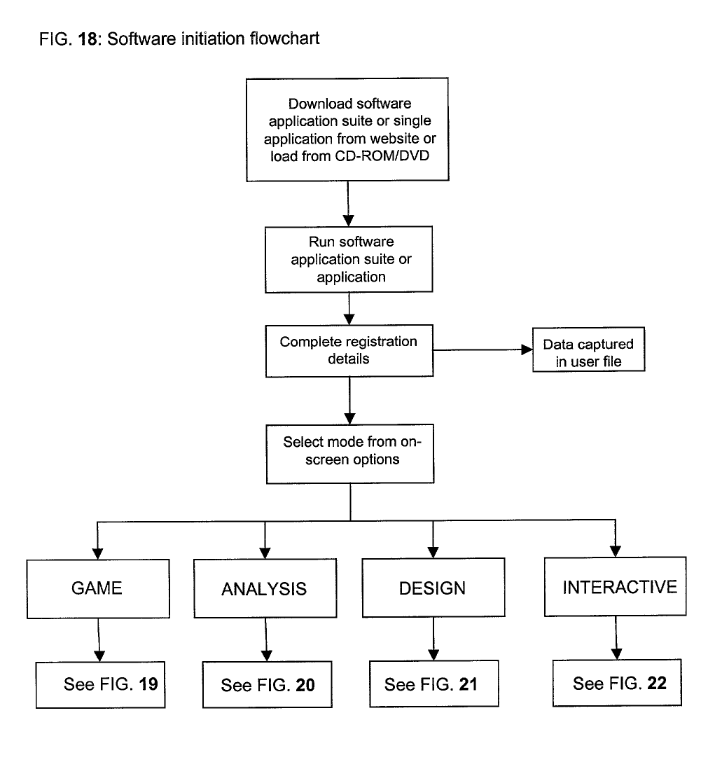

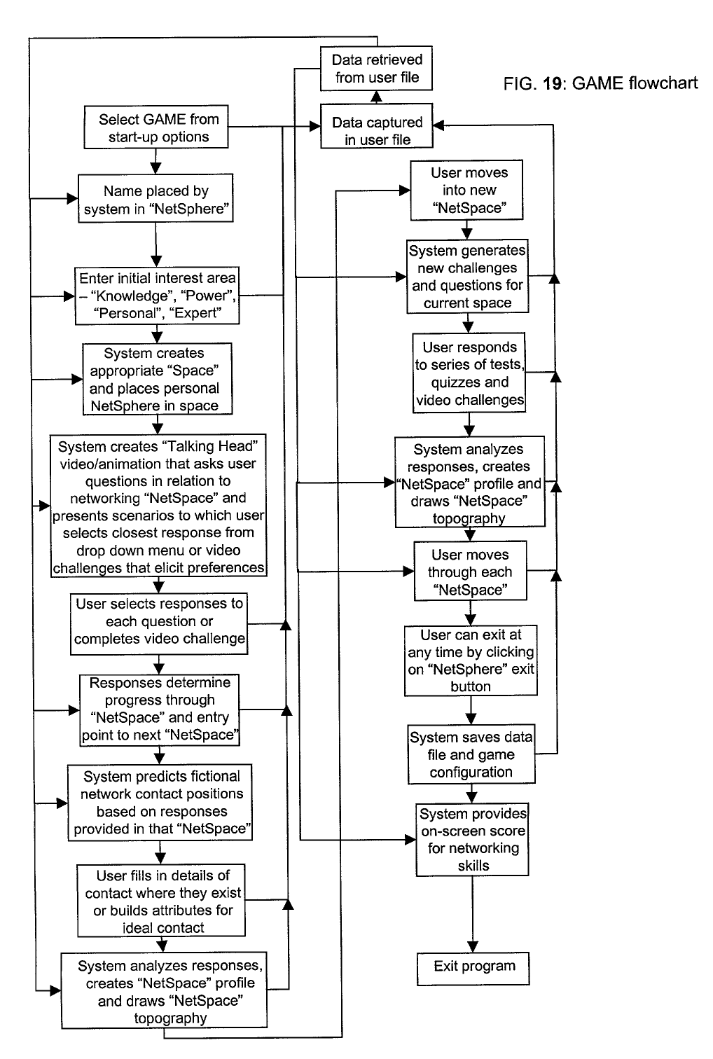

FIG. 18 provides an example of a flowchart outline of the initiation of the different software modes. In this embodiment, following the loading or downloading of the software application, the completion of registration details and the creation of a central user file, the user may select either a Game mode, Analysis mode, Design mode or Interactive mode. An example of the logic for each mode is described in the flowcharts shown in FIGS. 19-22.

In another embodiment, illustrated in the process flowchart shown in FIG. 19, the user selects a game mode at the start-up selection screen. An example of the game mode is described in FIGS. 13-16 in which a user selects a space in which to play, for example, the knowledge space, power space, personal space or expert space. These spaces provide context-specific challenges and questions that elicit behavioral and personal style preferences in a game environment. The system presents the context-specific challenges based on the selections made by the user, predicts network contact positions and analyzes user responses to create profiles and topographies that describe some of the issues the user defines as a consequence of their responses during the game. The user may move through different “NetSpaces”, testing their knowledge, preferences and relationship skills over a period of time.

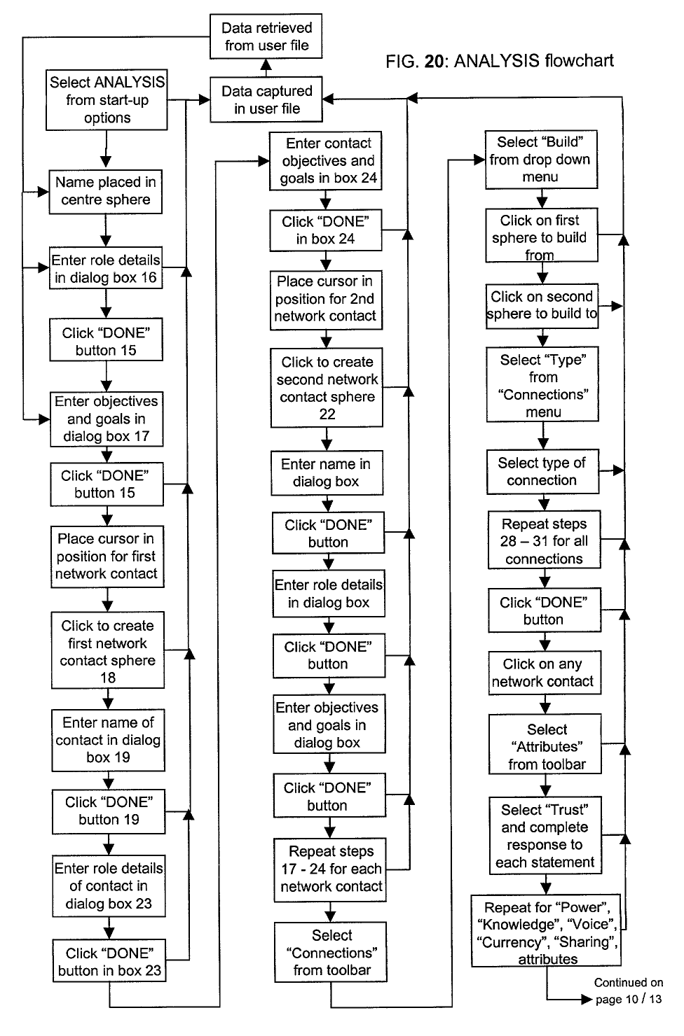

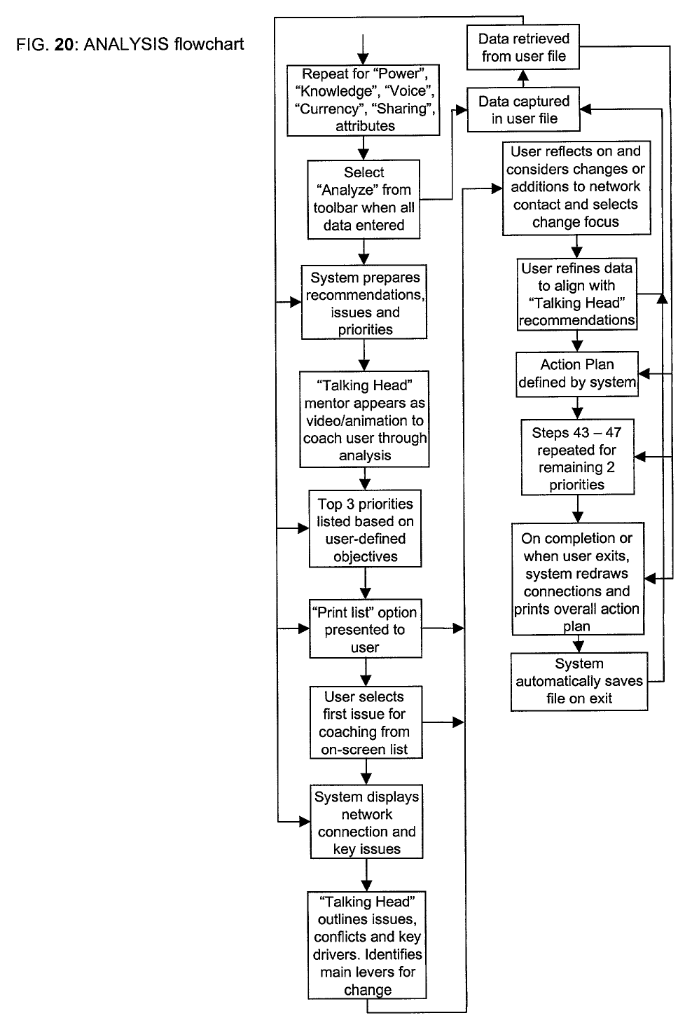

FIG. 20 provides an example of a flowchart of the logic for an Analysis mode. By way of example, in the analytical mode, the user begins by defining their role and the objectives that they are trying to achieve, creates a series of network contacts by placing them in the appropriate positions on the screen, and then allocates objectives for each network contact. Connections are created between the user sphere and the network contact spheres and each network contact has a series of attributes defined that specifies, for example, their respective Power, Knowledge, Trust, Voice, Sharing and other relationship currencies. On completion of the attributes, the user selects an Analysis option from, for example, the toolbar in a Microsoft Windows™ graphic user interface environment. The system then provides the user with an analysis of key issues arising from any conflicts between objectives, styles and preferences and prepares, for example, prioritized issues and recommendations. In another embodiment, “talking head” virtual coach 35 may be invoked to coach the user through the analysis. The output of the analysis may be printed in hard copy and the user may then refine the attribute data for specific network contacts to align with the recommendations provided by the analysis. An action plan may then be created by the system for implementation by the user. The system automatically saves any user inputs and modifications on user exit from the system.

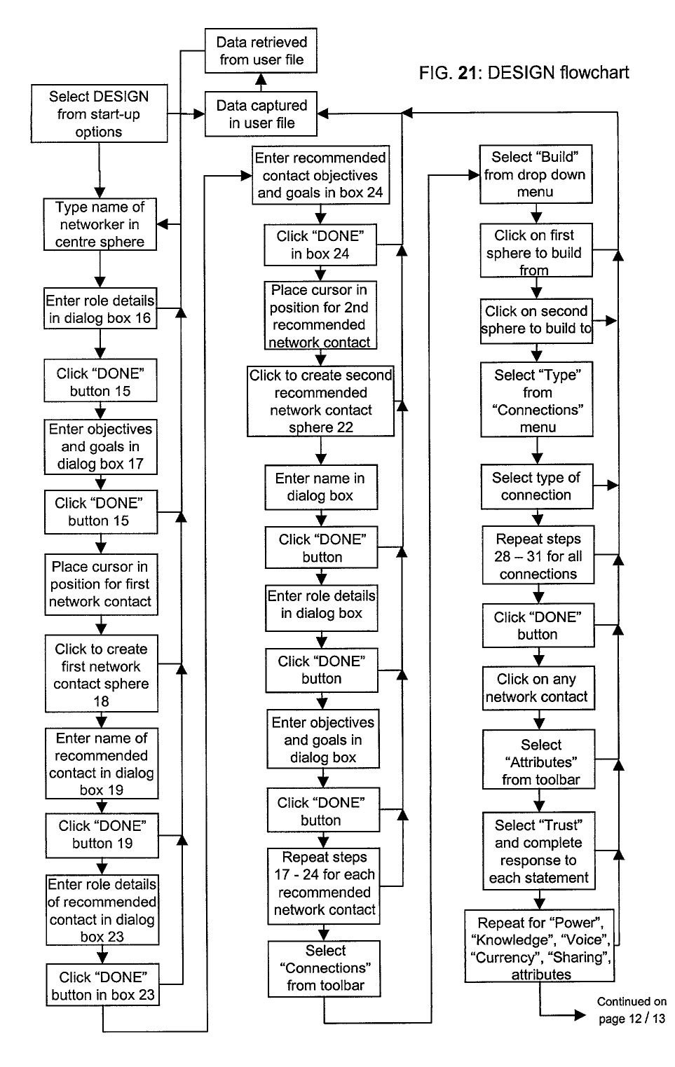

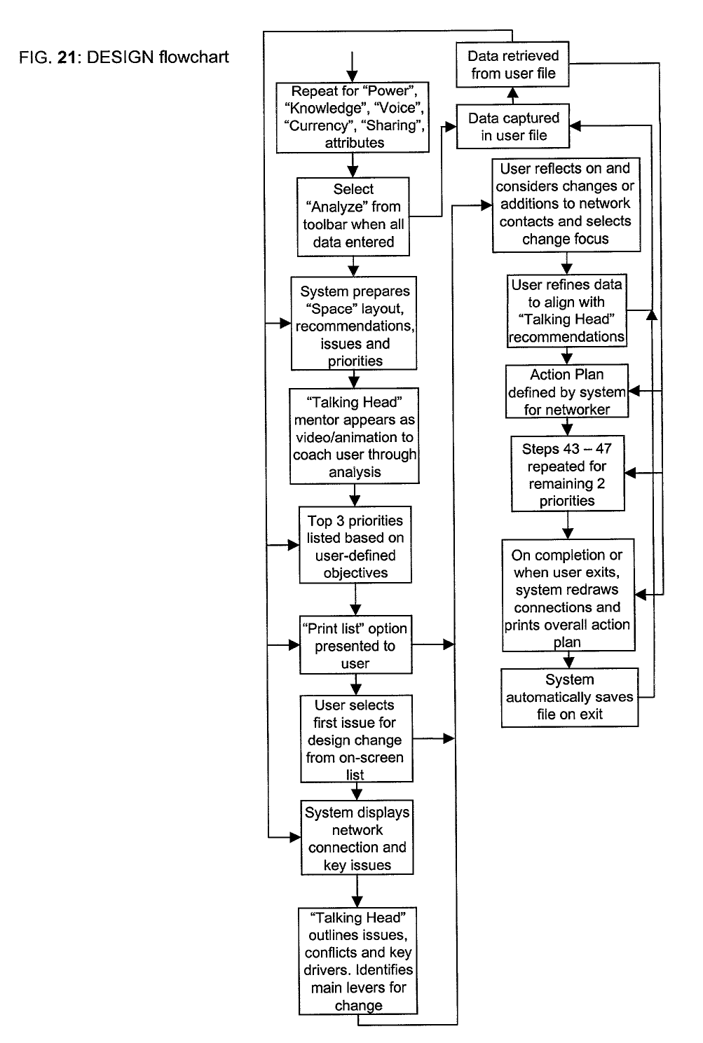

In yet a further embodiment, illustrated in the process flow diagram shown in FIG. 21, the user selects a design mode at the start-up selection screen. In the design mode, the user can design the desired network connections for either themselves or, for example, for a subordinate whom they manage in an organization. By way of example, a Research Manager in an organization may want to design a desired network for one of his or her subordinates. The manager creates a central “NetSphere” for the person in question, placing the subordinates name in the “NetSphere”. The manager then enters details of the subordinates role in dialog box 16 and then enters details of the subordinates desired objectives and goals in dialog box 17, as shown in FIG. 1. These details are saved to the subordinates data file that is held on the hard drive or removable media drive. The manager then creates network contact spheres for those people the manager believes the subordinate should network with, in order to fulfill the goals and objectives defined in the set-up. The manager may use the “drag and drop” functionality at this point to move network contact spheres to their desired positions.

As shown in FIG. 5, the manager connects the network spheres to the central “NetSphere”, selecting the types of connection (for example weak, strong, direct, indirect represented by different types of lines or 3-D, tubular pipe connections) the subordinate should have with each network contact. The manager then defines the attributes for each network connection by answering a series of questions and selecting from various statements, defines the network “Space” that each contact will occupy and the overall “NetSpace” focus for the subordinate (for example, whether the subordinate will focus on Knowledge, Power, Personal, or Expert “Spaces”), as shown in FIGS. 6,7, and 8. Having completed these details, the software invokes the “talking head” coach 35 and the issues and potential conflicts are fed-back to the manager for review. This may be achieved by comparing the responses provided by the manager to a database of existing statements that are representative of particular management issues.

Each of the responses provided by the manager are to specific questions or tasks completed by the manager. Thus, the context of each response is known and keywords may be identified in the manager's responses. These keywords are then matched to predefined statements in the database that describe the issues that may be causing the conflicts. The pre-defined statements may be selected by the software program by executing a “closest fit” sub-program that associates keywords with each pre-defined statement. This results in the selection of the most suitable answers. The software program then executes another sub-program that generates the “talking head” animation and converts the “closest fit” answers into human voice through a voice synthesizer (such as Lucent Technologies' Text-To-Speech engine) or through pre-recorded digital files of each answer. Another sub-program modifies the facial movements and expressions of the “talking head” to best fit the voice file answers provided. Suitable software for creating a “talking head” is now available, such as Faceworks™ by Digital or that shown on website www.lce.hut.fi/research/face/demo.html. The “talking head” virtual coach 35 may also be configured as a cartoon animation of a human being, computer-generated, animated, human-character graphics, or as pre-recorded, digital video and audio files of a real, human being.

In yet another embodiment, the virtual coach may be based on audio outputs, on-screen video outputs, on-screen or printed text outputs, or combinations of all of these. Modifications to the desired network topography are then considered and entered by the manager. This configuration is then used by the manager to help a new member of a team or new employee understand where to focus their time and efforts and allows improved performance management.

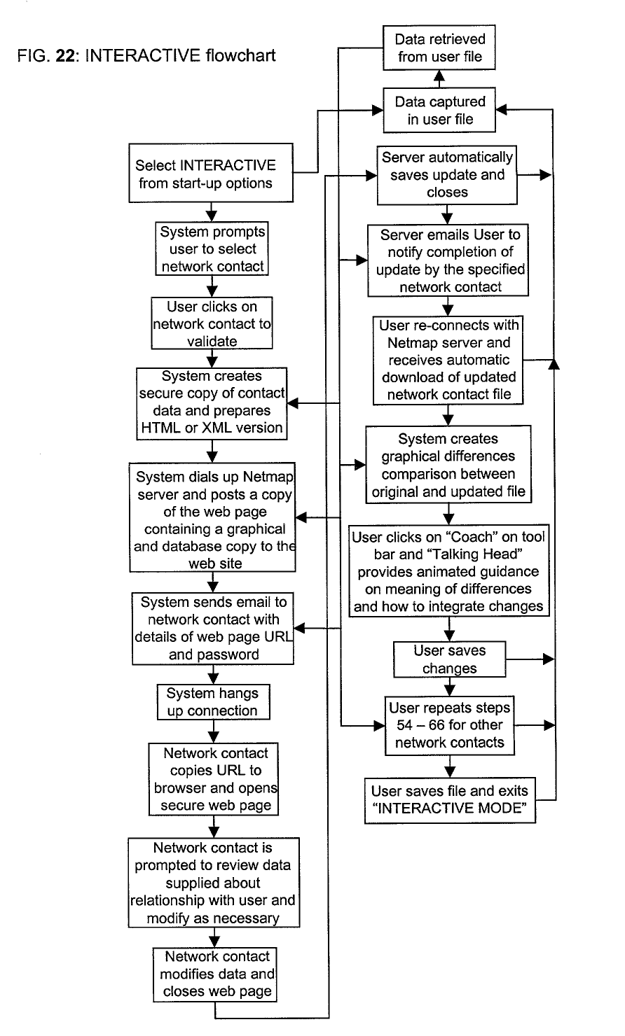

FIG. 22 outlines the process flow diagram for the interactive mode where, by way of example, a user may validate their assessment of a network contact's relationship details by posting, for example, a graphical copy of the user's assessment to a secure web site and allowing the network contact to modify or confirm the user's assessment. In this embodiment, the virtual coach may then provide guidance on the meaning of any differences between the user's assessment and the responses from the network contact.

Although described with particular reference to games and tools aimed at improving networking skills and capabilities, it will be appreciated that the tools and games, as described, can be used for the improvement, development and training of many management techniques, skills and capabilities. In certain applications, it is preferable that the games and tools are provided as an integrated suite, so as to facilitate the smooth transition of game players into professional tool users, and to leverage the learning gained from the game play into the design and analytical modes.

Accordingly, the scope of the present invention is to be defined by the following claims, including equivalents thereof, and is not limited to the particular illustrative examples described above.

We claim:

1. A method for identifying an individual's personal, human networking style and capabilities through the use of interactive, software-program games or tools.

2. The method according to claim 1 wherein said computer software acquires, captures, retrieves and displays information about a person's attitudes, behaviors and characteristics in relation to human networking with other individuals in an interactive, graphical form.

3. The method according to claim 1 wherein said computer software contains design functions for managers to create a desired, networking framework for their subordinates.

4. The method according to claim 1 wherein said computer software contains analysis and design functions for project management activities.

5. The method according to claim 1 wherein said computer software contains analysis and design functions for performance management activities.

6. The method according to claim 1 wherein said computer software contains analysis and design functions for process management activities.

7. The method according to claim 1 wherein said computer software contains analysis and design functions for training and development activities.

8. The method according to claim 1 wherein said computer software connects and displays the network analyses of multiple users within a team, group, department, organization, organizations or community in a graphical display of a multi-user network system.

9. The method according to claim 1 wherein said computer software enables the individual who is identified as the user's network connection to validate a user's own assessment.

10. A method for providing guidance on personal, human networking through the use of interactive, computer software games or tools.

11. A method for providing personal guidance and advice through interactive computer software tools that deliver said guidance in a human context through the use of a humanized, virtual coach.

12. The method according to claim 11 wherein the virtual coach is a talking head.

13. The method according to claim 11 wherein said computer software for personal coaching relates to organizational or management issues.

14. The method according to claim 11 wherein said computer software for personal coaching relates to personal issues.

15. A method of constructing a human contacts network model that is displayable through use of a computer, the method comprising the steps of:
receiving a plurality of information regarding a user;
constructing a user icon for display, the user icon based upon the plurality of information regarding the user;
constructing a first contact icon, the first contact associated with a first contact person;
constructing a second contact icon, the second contact associated with a second contact person;
linking the user icon with the first contact icon using a first relationship link, the relationship link associated with relationship currency information with respect to a personal relationship between the user and the first contact; and
linking the user icon with the second contact icon using a second relationship link, the second relationship link associated with relationship currency information with respect to a personal relationship between the user and the second contact.

16. The method of claim 15, wherein the relationship currency information is an indication of a perceived level of trust.

17. The method of claim 15, wherein the relationship currency information is an indication of a perceived level of mutuality.

18. The method of claim 15, wherein the relationship currency information is an indication of a perceived level of predictability.

19. The method of claim 15, wherein the relationship currency information is an indication of a perceived level of knowledge.

20. The method of claim 15, wherein the relationship currency information is an indication of a perceived level of power and/or influence.

21. The method of claim 15, wherein the network model can be manipulated by the user graphically in accordance with various user selections.

22. The method of claim 21, wherein the various user selections include a plurality of different network spaces.

23. The method of claim 21, wherein the network model is displayed on a monitor to the user using three dimensional computer graphics.

24. A method of using a human contact's network model for multiple users of an organization, where the human contact's network model is displayable through use of a computer, the method comprising the steps of:
inputting a plurality of information regarding a first user within an organization;
displaying a first user icon, the first user icon identified with the plurality of information regarding the first user;
displaying a first contact icon, the first contact associated with a first contact person;
displaying a second contact icon, the second contact associated with a second contact person;
linking the first user icon with the first contact icon using a first relationship link for the first user, the first relationship link associated with relationship currency information with respect to a personal relationship between the first user and the first contact;
linking the first user icon with the second contact icon using a second relationship link, the second relationship link associated with relationship currency information with respect to a personal relationship between the first user and the second contact;
inputting a plurality of information regarding a second user within an organization;
displaying a second user icon, the second user icon identified with the plurality of information regarding the second user;
displaying a third contact icon, the third contact associated with a third contact person;
displaying a fourth contact icon, the fourth contact associated with a fourth contact person;
linking the second user icon with the third contact icon using a third relationship link for the second user, the third relationship link associated with relationship currency information with respect to a personal relationship between the second user and the third contact;
linking the second user icon with the fourth contact icon using a fourth relationship link, the fourth relationship link associated with relationship currency information with respect to a personal relationship between the second user and the fourth contact; and
linking the first user icon with the second user icon using a fifth relationship link, the fifth relationship link associated with relationship currency information with respect to a personal relationship between the first user and the second user.

25. The method of claim 24, where access to different levels of user information are set by a method, the method comprising of:
the first user selects the level of access available, and thereby the information displayed, to the second user for the plurality of information with respect to the first user, with respect to the plurality of relationship links with each first user contact, and with respect to the plurality of information associated with each first user contact; and
the second user selects the level of access available, and thereby the information displayed, to the first user for the plurality of information with respect to the second user, with respect to the plurality of relationship links with each second user contact, and with respect to the plurality of information associated with each second user contact.

26. The method of claim 24, further comprising training personnel through use of the human contacts network model constructed for the first and second user.

27. The method of claim 26, wherein the training includes network management training based on management objectives of the organization.

28. The method of claim 24, further comprising interacting with the first and second users through interactive question and answer sessions and modifying the network model based on said interactive question and answer sessions.

29. A method of interacting with a human contact network model, the method comprising.
providing a first version of a human contact network model that includes a user icon that provides information regarding a first person, a plurality of contact icons that provide information regarding a plurality of other persons, and a plurality of relationship links that provide information regarding a personal relationship between the first person and at least one of the other persons; and
modifying the first version of the human contact network model to create a second version of the human contact network model.

30. The method of claim 29, wherein the first version of the human contact network is modified to create the second version based on a perceived change in behavior of the first person or of the other persons or based on a perceived change in the personal relationships between the first person and at least one of the other persons.

31. The method of claim 29, wherein at least one of the relationship links is indicative of relationship currency information with respect to a personal relationship between the first person and at least one of the other persons.

32. The method of claim 29, wherein the relationship currency information is an indication of a perceived level of trust.

33. The method of claim 29, wherein the relationship currency information is an indication of a perceived level of mutuality.

34. The method of claim 29, wherein the relationship currency information is an indication of a perceived level of predictability.

35. The method of claim 29, wherein the relationship currency information is an indication of a perceived level of knowledge.

36. The method of claim 29, wherein the relationship currency information is an indication of a perceived level of power and/or influence.

37. The method of claim 29, wherein the second version contains a contact icon that was modified by a second person associated with the contact icon.

38. The method of claim 37, wherein the contact icon is modified in response to data communications over a distributed computer network.

39. A computer implemented system for interacting with a human contact network model, the computer implemented system comprising:
a user interface to display a first version of a human contact network model that includes a user icon that provides information regarding a first person, a plurality of contact icons that provide information regarding a plurality of other persons, and a plurality of relationship links, at least one of the plurality of relationship links providing information regarding a personal relationship between the first person and at least one of the other persons; and
a user based network model editing function for modifying the first version of the human contact network model to create a second version of the human contact network model.

40. The system of claim 39, wherein the first version of the human contact network is modified to create the second version based on a perceived change in behavior of the first person or of the other persons or based on a perceived change in the personal relationships between the first person and at least one of the other persons.

41. The system of claim 39, wherein at least one of the relationship links is indicative of relationship currency information with respect to a personal relationship between the first person and at least one of the other persons.
